(19) United States
(12) Patent Application Publication
(10) Pub. No.: US 2004/0178186 A1
(43) Pub. Date: Sep. 16, 2004

(54) Portable warming cloth for containers

(76) Inventor: William Lu, Taipei Hsien (TW)

Correspondence Address: BACON & THOMAS, PLLC, 625 SLATERS LANE, FOURTH FLOOR, ALEXANDRIA, VA, 22314

(21) Appl. No.: 10/386,514

(22) Filed: Mar. 13, 2003

(51) Int. Cl. H05B 3/34

(52) U.S. Cl. 219/438; 219/521; 219/528; 219/549

(57) ABSTRACT

The present invention relates to a portable warming cloth for containers using office equipment such as USB or IEEE1394 (Fire Wire) plugs as heating source. The present invention mainly comprises a USB plug or IEEE1394 plug, power source wire, electric heating plates and a cloth. The USB or IEEE1394 plug can be plugged to USB or IEEE1394 receptacle or other transition plug at any time. The power source wire is pliable and designed with a connecting point at the rear part for connection of heating plates, a LED indicating power button in the middle and a USB and IEEE1394 plug at the front part. The heating plates use direct current and are secured inside the cloth. A concealed connecting stand is found at the lower part of the electric heating plates for connecting of power source wire. The cloth is made of soft material with adhesive tapes on both sides and apart from the electric heating plates found inside, it is also designed in advance with a side opening. Hence, the present invention provides a very convenient warming cloth for warming coffee cups or food containers on a table surface or in a car.

### TECHNICAL RANGE

The present invention relates to a portable warming cloth for containers especially one using office equipment such as USB or IEEE1394 (Fire Wire) plugs as heating source.

### INVENTION BACKGROUND

There are two kinds of commonly used warming methods for containers namely self-warming and heat warming method. Self-warming method usually uses special warming material to prevent lost of temperature and heat warming method uses a hot plate wherein a cup or bottle is placed upon for heating effect.

The two methods mentioned above are limited to some factors such as sizes and material of containers as well as environment. This is a drawback for office workers using computers or the like advanced equipment and drivers who require warm food for more energy and spirit but find present heating methods inconvenient and much in the way.

### SUMMARY OF INVENTION

The present invention relates to a portable warming cloth using USB or IEEE1394 plugs as heating source to enable computer or the like equipment users to connect warming cloth to USB or IEEE1394 plug.

The present invention relates to a portable warming cloth wherein containers to be heated are surrounded by said warming cloth and warmed by heating plates secured inside in order to ensure desired temperature for a long period of time.

The present invention relates to a portable warming cloth wherein said warming cloth is designed with a side opening for insertion of cup handles and a transition plug is also provided for use of the present invention in cars.

The present invention relates to a portable warming cloth wherein the power source wire can be connected and disconnected at any time to the warming cloth due to a concealed connecting stand found at the lower part of the heating plates.

### MODE FOR CARRYING OUT INVENTION

With reference to FIG. 1 showing a view of the present invention, warming cloth 10 mainly consists of USB or IEEE1394 plugs 11, power source wire 12, electric heating plates 13 and cloth 14. The USB or IEEE1394 plugs 11 can be inserted to USB or IEEE1394 receptacles of computers or the like equipment at any time and a transition plug is also provided for use of warming cloth in cars. The power source wire 12 is pliable and designed with a connecting point (not shown in diagram) at the front part for connection or disconnection of a concealed connecting stand found at the lower part of the electric heating plates 13. Further, a LED power indicating button 15 is found in the middle and a USB or IEEE1394 plug 11 is found at the front part. Said electric heating plates 13 use direct current and are secured inside the cloth 14 and a concealed connecting stand (not shown in diagram) is found at the lower part for connection of power source wire 12. If a connecting stand is not designed, the power source wire 12 is directly connected to the electric heating plates. The cloth 14 is made of soft material with adhesive tapes on both sides and apart from the electric heating plates 13 found inside, it is also designed in advance with a side opening 17. With reference to FIG. 2 showing a view of the present invention in use, said coffee cup 20 is surrounded by cloth 10 and secured by adhesive tapes 16 (not shown in diagram) found on both sides and the cup handle 21 is inserted through side opening 17. A LED power indicating button 15 is designed in the power source wire 12 extended from the lower part of the electric heating plates 13 to indicate power status with ON and OFF indications.

The above-mentioned mode is applicable to any kinds of containers such as cups, bottles, cans, lunch boxes, milk bottles and so on.

### DESCRIPTION OF DRAWINGS

FIG. 1 shows a view of the present invention.

FIG. 2 shows a view of view of the present invention in use.

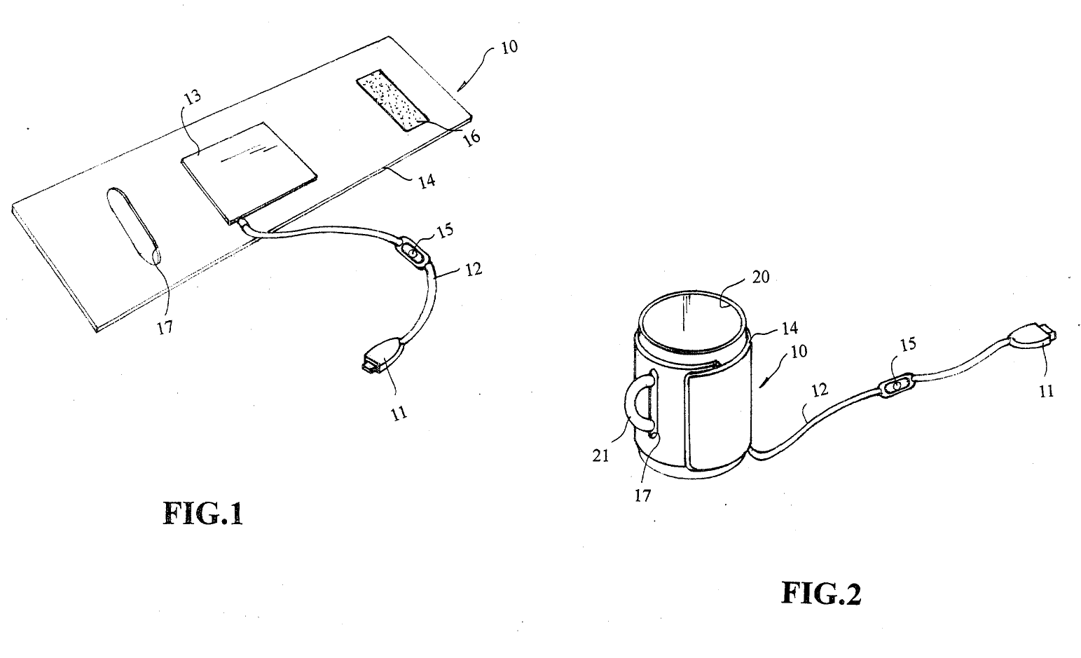

Numericals

10—warming cloth 11—USB or IEEE1394 (Fire Wire) plug

12—power source wire 13—electric heating plates

14—cloth 15—LED indicating button

16—adhesive tapes 17—side opening

20—coffee cup 21—cup handle

1. A kind of “Portable warming cloth for containers” mainly consisting of a USB or IEEE1394 plug, power source wire, electric heating plates and cloth wherein:
Said USB or IEEE1394 plug can be connected to USB or IEEE1394 receptacle at any time and other transition plugs;
Said power source wire is pliable and designed with a connecting point at the rear part, a LED indicating button in the middle and a USB or IEEE1394 plug at the front part;
Said electric heating plates use direct current and are secured inside the cloth. A concealed connecting stand is found at the lower part for connection of power source wire;
Said cloth is made of soft material with adhesive tapes on both sides and apart from electric heating plates found inside it is also designed in advance with a side opening wherein characterized.

2. As mentioned in claim 1 of a kind of “Portable warming cloth for containers”, the transition plug is first connected to USB or IEEE1394 plug and then to power source of car lighters.

3. As mentioned in claim 1 of a kind of “Portable warming cloth for containers”, the connecting point found at the rear part of the power source wire is to facilitate connection of electric heating plates or disconnection of power source wire if needed.
